(19) United States
(12) Patent Application Publication
(10) Pub. No.: US 2023/0056454 A1
(43) Pub. Date: Feb. 23, 2023

(54) HANDHELD FOOD PRODUCT

(71) Applicant: SCOTT FRASER, OAK HARBOR, WA (US)

(72) Inventor: SCOTT FRASER, OAK HARBOR, WA (US)

(21) Appl. No.: 17/876,391

(22) Filed: Jul. 28, 2022

Related U.S. Application Data
(60) Provisional application No. 63/226,746, filed on Jul. 28, 2021.

(51) Int. Cl. A23L 7/109; A23L 23/00; A23L 5/10; A23P 20/10

(52) U.S. Cl. CPC A23L 7/111; A23L 23/00; A23L 5/10; A23P 20/10; A23V 2002/00

(57) ABSTRACT

A method includes cooking a first human-edible ingredient for a predetermined time period, combining a second human-edible ingredient with a human-edible binder to form a sauce, cooking the sauce for a predetermined time period, enclosing the first human-edible ingredient and the sauce in a casing to form an encased portion, cooling the encased portion to a predetermined temperature, removing the casing from the portion, battering and breading the portion, cooling the battered and breaded portion to a predetermined temperature, and cooking the battered and breaded portion for a predetermined time period.

### COPYRIGHT NOTICE

This disclosure is protected under United States and/or International Copyright Laws. © 2022 Scott Fraser. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### PRIORITY CLAIM

This application claims priority to U.S. Prov. Pat. Appl. No. 63/226,746 filed Jul. 28, 2021, the contents of which are hereby incorporated by reference as if fully set forth herein.

### BRIEF DESCRIPTION OF THE DRAWING FIGURES

FIG. 1 schematically illustrates a process according to an embodiment of the invention; and

FIG. 2 illustrates in cross-section an exemplary product of the process illustrated in FIG. 1 according to an embodiment of the invention.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

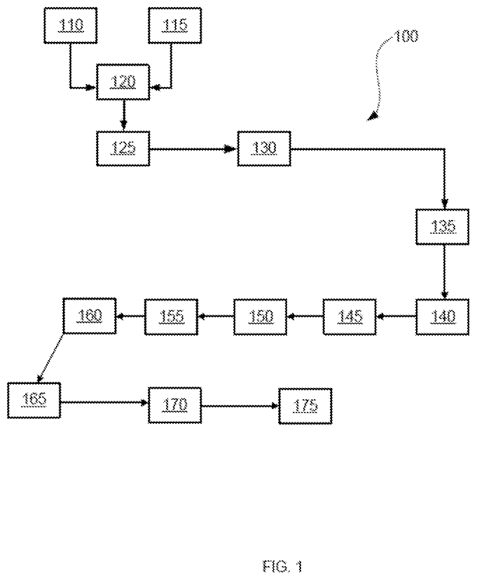

FIG. 1 illustrates a process according to an embodiment of the invention. At a step 110, a human-edible solid, such as pasta (e.g., spaghetti) for non-limiting example, is cooked to a predetermined consistency and/or for a predetermined time period. Likewise, at a step 115, a human-edible fluid, such as tomato sauce for non-limiting example, is cooked for a predetermined time period. In an embodiment, a human-edible binder, such as agar or gelatin for non-limiting example, is added to the tomato sauce. In an embodiment, the combined sauce and binder (hereinafter referred to simply as “the sauce”) is simmered for five minutes. At a step 120, the sauce is combined with the freshly cooked hot unrinsed pasta to form a pasta mixture. In an embodiment, while constantly being stirred, the pasta mixture is cooled to, for example, 140° F.

Then, at a step 125, the 140° F. pasta mixture is placed into, for example, an extruder/stuffer. The pasta mixture can be pushed or sucked through a small opening in the machine that applies a casing, such as one made of cellulose for example, to the pasta mixture. The encased pasta mixture can form a long hot-dog style rope that, in an embodiment, can be up to 30 feet in length. To make it easier to handle, this pasta rope can be twisted and linked into 3-, 4-, 6- or 8-foot lengths. Then, at a step 130, the encased pasta ropes are cooled down to, for example, 30° F.-40° F. for a minimum of, for example, four hours. This cooling allows the binder in the sauce to set and bind the pasta together.

After the pasta ropes have set, at a step 135, the pasta ropes are put through a peeler machine or treated via an alternative method to remove the casing. The uncased pasta ropes are then cut into portions of a predetermined size. At steps 140-155, the portions are battered and breaded twice. In an alternative embodiment, the portions can be battered and breaded only once. At a step 160, the portions are placed into a freezer and frozen.

At a step 165, the portions are fried. A quick flash-fry can set and cook the batter that has been applied to the portions to a golden brown. After frying, and at a step 170, the pasta portions are once again frozen. Then, at a step 175, the frozen portions are boxed and ready for transport to distributors.

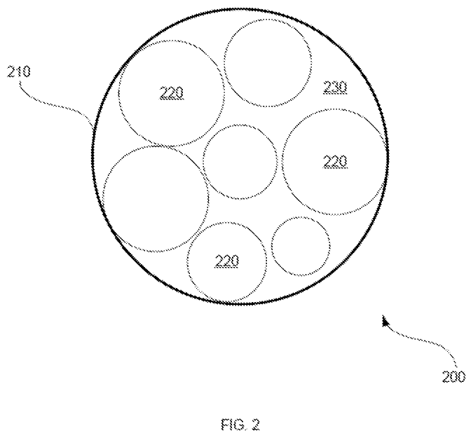

FIG. 2 illustrates in cross-section an exemplary product of the process illustrated in and discussed with reference to FIG. 1. Specifically, shown in cross-section is a fried pasta and sauce portion 200 discussed above herein. As shown, the portion 200 includes a batter/breading layer 210 in which is encased the cooked pasta 220 and the sauce 230 interstitial to the pasta.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. For example, further exemplary products that can be yielded by the process discussed with reference to FIG. 1 include, but are not limited to, Pasta and Meatball Sticks, Alfredo Sticks, Chicken Alfredo Sticks, and Broccoli and Cheese Sticks. Such products can be Gluten Free, Vegetarian or Vegan. Accordingly, it should be understood that the methods and apparatus described herein are illustrative only and are not limiting upon the scope of the claims.

What is claimed is:

1. A method, comprising the steps of:
cooking a first human-edible ingredient for a predetermined time period;
combining a second human-edible ingredient with a human-edible binder to form a sauce;
cooking the sauce for a predetermined time period;
enclosing the first human-edible ingredient and the sauce in a casing to form an encased portion;
cooling the encased portion to a predetermined temperature;
removing the casing from the portion;
battering and breading the portion;
cooling the battered and breaded portion to a predetermined temperature; and
cooking the battered and breaded portion for a predetermined time period.
